(19) United States
(12) Patent Application Publication
(10) Pub. No.: US 2016/0271457 A1
(43) Pub. Date: Sep. 22, 2016

(54) Inner tube and manufacturing method thereof

(71) Applicant: TongCheng HuiLong Sports Articles Co.,Ltd., Xianning (CN)

(72) Inventor: Yadong Lu, Xianning (CN)

(73) Assignee: TongCheng HuiLong Sports Articles Co.,Ltd.

(21) Appl. No.: 15/144,813

(22) Filed: May 3, 2016

(30) Foreign Application Priority Data
Mar. 18, 2016 (CN) 201610155893.6

(51) Int. Cl. A63B 41/02; B29C 63/24; B29C 71/02; B29C 63/00

(52) U.S. Cl. CPC A63B 41/02; B29C 63/0073; B29C 63/0069; B29C 63/24; B29C 71/02; B29L 2031/54

(57) ABSTRACT

An inner tube includes a tube body, a yarn layer and a rubber layer, wherein the yarn layer is attached to an external surface of the tube body, the rubber layer is attached to an external surface of the yarn layer and is then vulcanized, in such a manner that a rubber raw material of the rubber layer permeates through yarn gaps of the yarn layer, so as to integrate the tube body, the yarn layer with the rubber layer. The inner tube provided by the present invention has excellent jumping ability, high strength, good durability, small circumferential error, and excellent balance and flight stability.

### CROSS REFERENCE OF RELATED APPLICATION

The present invention claims priority under 35 U.S.C. 119(a-d) to CN 201610155893.6, filed Mar. 18, 2016.

### BACKGROUND OF THE PRESENT INVENTION

1. Field of Invention

The present invention relates to a technical field of sports goods, and more particularly to an inner tube and a manufacturing method thereof.

2. Description of Related Arts

The inner tube of conventional sewn balls, such as footballs and volleyballs, includes three structural forms as follows: (1) rubber inner tube; (2) yarn tire by winding a layer of yarn around the exterior of the rubber inner tube; and (3) cloth tire by attaching a layer of cloth to the exterior of the rubber inner tube. Shortcomings of the above three structural forms are respectively described as below.

Shortcomings of the first structure are: firstly, due to the flexibility of the rubber inner tube, the rubber inner tube is able to expand unlimitedly without forming while being injected with the gas, and the expanding force is directly applied to the housing, so that the housing easily bursts to expose seaming lines till the ball finally bursts; secondly, the rubber inner tube has poor gas tightness, after a long period, the sufficient gas gradually slowly leaks, so that the gas always needs to be added, thereby it is not convenient for usage; thirdly, the gas nozzle of the rubber inner tube is located at one side thereof, the gas nozzle and a circle of the yarn reinforcement layer, which is around the gas nozzle and attached to the rubber inner tube, allow the center of gravity of the whole ball to trend to the side where the gas nozzle is located, so that the center of gravity of the ball is unbalanced, which leads to the unstable flight.

Shortcomings of the second structure are: a layer of yarn is wound around the exterior of the rubber inner tube, and the basic circumference of the rubber inner tube is restrained with the yarn to set the shape of the rubber inner tube and increase the striking breaking strength of the ball. However, after the yarn tire is injected with the gas, the whole ball is hard and easily hits hands. Simultaneously, once the whole ball is hard, the flight balance becomes poor when the ball flies. Accordingly, the hard ball not only has poor rebound, but also results in poor sense control force of the player. Furthermore, during the manufacturing process of the yarn tire, the yarn is mechanically wound around the rubber inner tube, and however, the mechanical wound yarn tire is unable to ensure the circumferential error of the ball, the circumferential error generally reaches 3-5 mm, which leads to poor balance and jumping ability, and unstable flight of the ball.

Shortcomings of the third structure are: a layer of cloth is attached to the exterior of the rubber inner tube to form the cloth tire. For example, Chinese Patent No. 201020150442.1 discloses a football, which includes a sheath and a liner, wherein a layer of cloth is located between the sheath and the liner. Compared with the yarn tire, the cloth tire has soft surface after being injected with the gas. However, the cloth tire, obtained by replacing the yarn with the cloth, has poor forming, low striking breaking strength of the ball, and large circumferential error (in generally, which reaches 3-5 mm), so that it has poor jumping ability, poor balance, unstable flight, insufficiently strength and poor durability.

Therefore, the rubber inner tube is able to continuously expand with the increase of the internal gas, so that it is unable to control the ball to achieve the determined shape and size, thus the gas leakage easily appears. In spite that the yarn tire is able to avoid a burst during tire inflation and plays a role in forming, due to the ball is mechanically wound with yarns, the yarns are always unevenly wound, so that the ball is unable to be completely controlled to achieve the determined shape. Similarly, in spite that the cloth tire is able to play a role in forming, the cloth has various latitude and longitude lines, which leads to uneven tensions, so that it is unable to completely control the ball to achieve the determined shape.

### SUMMARY OF THE PRESENT INVENTION

An object of the present invention is to overcome shortcomings of the prior art for providing an inner tube which has excellent jumping ability, high strength, good durability, small circumferential error, and excellent balance and flight stability.

Accordingly, in order to accomplish the above object, the present invention provides an inner tube, which comprises a tube body, a yarn layer and a rubber layer, wherein the yarn layer is attached to an external surface of the tube body, the rubber layer is attached to an external surface of the yarn layer and is then vulcanized, in such a manner that a rubber raw material of the rubber layer permeates through yarn gaps of the yarn layer, so as to integrate the tube body, the yarn layer with the rubber layer.

Furthermore, the inner tube is a football or volleyball inner tube.

Furthermore, a circumferential error of the inner tube is less than 2 mm.

Furthermore, a thickness of the yarn layer is 0.1-1 mm.

Furthermore, a balance plate is attached to the inner tube and located at a position where is coaxially aligned with a gas nozzle and symmetrical to a spherical center.

Furthermore, the rubber layer is an ordinary rubber layer or a foamed rubber layer; after vulcanization, an external surface of the rubber layer forms a layer of dense rubber membrane.

Furthermore, the tube body is a double layer tube body comprising an internal layer body and an external layer body tightly attached to the internal layer body.

Furthermore, the rubber layer comprises an internal layer rubber, a yarn reinforcement layer and an external layer rubber, wherein the internal layer rubber is attached to an interior of the yarn layer, the yarn reinforcement layer is attached to an external surface of the internal layer rubber, the external layer rubber is attached to an external surface of the yarn reinforcement layer.

According to the inner tube, the present invention also provides a manufacturing method of the inner tube, which comprises steps of:

(1) preparing a tube body fittingly with a roundness of a ball;

(2) preparing a yarn ball comprising injecting gas into the tube body, and measuring a periphery thereof, winding yarns around an external surface of the tube body with a yarn winding machine;

(3) preparing a rubber raw material ball by attaching a rubber raw material to an external surface of the yarn ball; and

(4) preparing a vulcanizing inner tube comprising steps of: putting the rubber raw material ball prepared by the step (3) into a vulcanizing mold, communicating a gas injection needle on the vulcanizing mold with a gas nozzle of the rubber raw material ball and pressurizing, heating and vulcanizing with a vulcanizing temperature of 95-160° C., a pressure of 3-10 kg/cm² and a vulcanizing time of 4-10 min, permeating the rubber raw material through yarn gaps after vulcanization, and vulcanizing mould unloading for obtaining the vulcanizing inner tube, wherein a circumferential error of the inner tube is less than 2 mm.

Furthermore, after the rubber raw material ball is prepared in the step (3), a balance plate is attached to a position where is coaxially aligned with the gas nozzle and symmetrical to a spherical center on the rubber raw material ball, and then the step (4) is processed.

Beneficial effects of the present invention are as follows:

(1) In the present invention, the yarn layer is wound around the external surface of the tube body, and the rubber layer is attached to the external surface of the yarn layer. After vulcanization, the rubber raw material of the rubber layer permeates through the yarn gaps of the yarn layer, in such a manner that the tube body, the yarn layer and the rubber layer form a whole, which has compact structure, excellent gas tightness, high strength and good durability. The thickness of the yarn layer provided by the present invention is preferably 0.1-1 mm. Under the premise of guaranteeing the enough restraint of the yarn layer to the tube body injected with gas, the thickness of the yarn layer is properly selected for improving the strength of the inner tube, and simultaneously giving consideration to both the hardness of the ball after being injected with gas and the jumping ability of the ball. Furthermore, after vulcanization with the vulcanizing mould, the rubber raw material of the rubber layer attached to the external surface of the yarn layer permeates through the yarn gaps of the yarn layer, to form the inner tube which sandwiches the yarn between the external rubber and the internal rubber, so that the surface softness of the ball injected with the gas is ensured, and meanwhile, the circumferential error of the ball is greatly reduced, thereby greatly improving the rebound ability of the ball.

(2) The balance plate is located at a position where is symmetrical to the gas nozzle on the inner tube for allowing the center of gravity of the manufactured ball to lie in the spherical center, so that the ball has excellent balance and the flight stability of the ball is ensured. Therefore, when a player hits the ball, an actual flight trajectory of the ball deviates from an ideal trajectory thereof in small, so that a hit rate of the ball is increased.

(3) After vulcanizing the inner tube with the vulcanizing mould, the circumferential error of the inner tube is able to be accurately ensured, so that the inner tube has small circumferential error and excellent jumping ability.

(4) Furthermore, the tube body provided by the present invention is a double layer tube body comprising an internal layer body and an external layer body tightly attached to the internal layer body, wherein the internal layer body is an ordinary single tube, the external layer body is able to limit the internal layer body to evenly expand to a needed shape and size, a hardness-softness and a degree of jumping of the internal layer body, so that a leakage phenomenon is effectively avoided to improve a service life of the ball.

(5) In spite that the existing yarn tire is able to avoid a burst during tire inflation and plays a role in forming, due to the ball is mechanically wound with yarns, the yarns are always unevenly wound, so that the ball is unable to be completely controlled to achieve a determined shape. To solve the above technical problem, the rubber layer of the present invention further adopts sandwiching the yarn reinforcement layer between the internal layer rubber and the external layer rubber. By a double forming of the yarn layer and the yarn reinforcement layer, the ball is completely controlled to achieve the determined shape, so that when the ball is squeezed in a long term and strongly impacted, the yarn reinforcement layer enhances a strength of an impact resistance of the ball, thus ensuring a resilience strength and an excellent jumping ability and prolonging the service life of the ball.

These and other objectives, features, and advantages of the present invention will become apparent from the following detailed description, the accompanying drawings, and the appended claims.

### BRIEF DESCRIPTION OF THE DRAWINGS

FIG. 1 is a partially structurally schematic view of an inner tube provided by the present invention.

FIG. 2 is a partially structurally schematic view of the inner tube according to the Embodiment 2 of the present invention.

FIG. 3 is a partially structurally schematic view of a double layer tube body according to the Embodiment 5 of the present invention.

FIG. 4 is a partially structurally schematic view of a rubber layer according to the Embodiment 6 of the present invention.

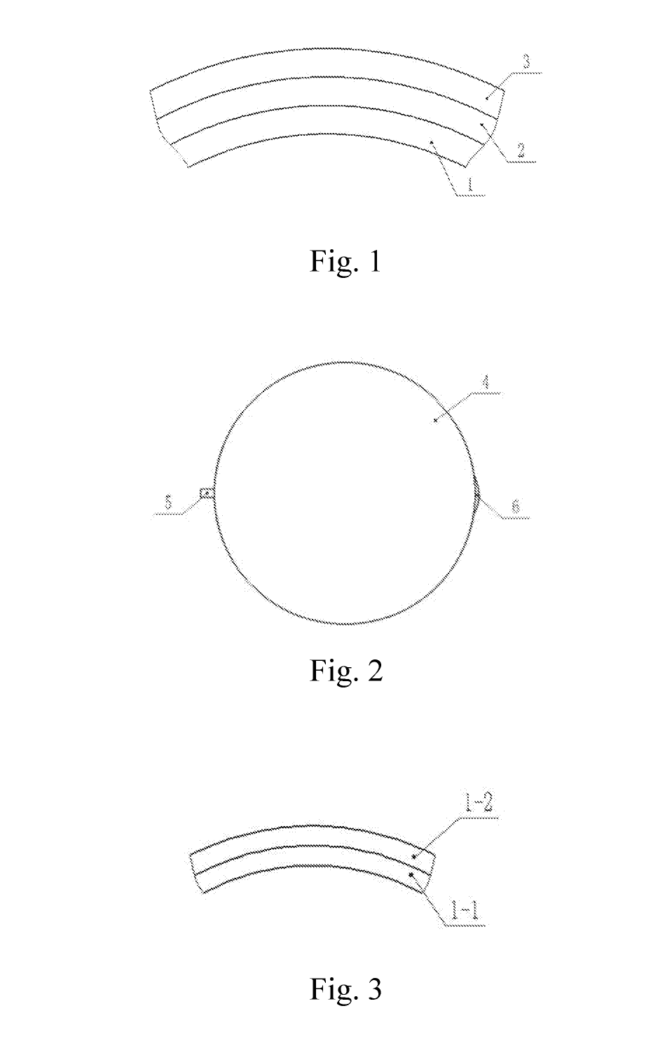

In the drawing,
1: tube body;
2: yarn layer;
3: rubber layer;
4: inner tube;
5: gas nozzle;
6: balance plate;
1-1: internal layer body;
1-2: external layer body;
3-1: internal layer rubber;
3-2: yarn reinforcement layer;
3-3: external layer rubber.

### DETAILED DESCRIPTION OF THE PREFERRED EMBODIMENT

The present invention is further described in detail accompanying with the drawing.

### Embodiment 1

Referring to the drawing, an inner tube 4 according to a preferred embodiment of the present invention is illustrated, comprising a tube body 1, a yarn layer 2 and a rubber layer 3, wherein the yarn layer 2 is attached to an external surface of the tube body 1, the rubber layer 3 is attached to an external surface of the yarn layer 2 and is then vulcanized, in such a manner that a rubber raw material of the rubber layer 3 permeates through the yarn layer 2, so as to integrate the tube body 1, the yarn layer 2 with the rubber layer 3.

### Embodiment 2

If the thicker yarn layer 2 winds around the tube body 1, a surface of the manufactured inner tube 4 is harder, so that a jumping ability of a ball is affected; and meanwhile, if the thinner yarn layer 2 winds around the tube body 1, the yarn layer 2 is unable to sufficiently bind up the tube body 1, so that the inner tube 4 has low strength, poor damage resistance and is not durable. To avoid the above situations, preferably, a thickness of the yarn layer 2 is 0.1-1 mm. Under a premise of guaranteeing an enough restraint of the yarn layer 2 to the tube body 1, the thickness of the yarn layer 2 is properly selected for improving the strength of the inner tube 4, and simultaneously giving consideration to both the surface hardness and the jumping ability of the ball.

### Embodiment 3

As shown in FIG. 2, if a balance and a flight stability of the ball are ensured, when a player hits the ball, an actual flight trajectory of the ball deviates from an ideal trajectory thereof in small, so that a hit rate of the ball is increased. Accordingly, a balance plate 6 is located on the inner tube 4 provided by the present invention, and is coaxially aligned with a gas nozzle 5 and symmetrical to a spherical center, in such a manner that a whole center of gravity of the inner tube 4 deviates from the spherical center in small, so that when the inner tube 4 attaches to a housing, due to a weight of the balance plate 6, the whole center of gravity of the ball lies in the spherical center.

### Embodiment 4

The rubber layer 3 of the present invention is an ordinary rubber layer or a foamed rubber layer. After vulcanization, an external surface of the rubber layer 3 forms a layer of dense rubber membrane. While the foamed rubber layer is adopted, after vulcanization, the surface of the inner tube 4 forms numerous foaming holes, so that the ball is soft, and meanwhile, the external surface of the rubber layer 3 forms the layer of dense rubber membrane, thus a gas tightness of the ball is improved and a leakage of gas inside the ball is avoided. Therefore, the ball has excellent gas tightness and compact structure.

### Embodiment 5

As shown in FIG. 3, preferably, the tube body 1 is a double layer tube body comprising an internal layer body 1-1 and an external layer body 1-2 tightly attached to the internal layer body 1-1, wherein the internal layer body 1-1 is an ordinary single tube, the external layer body 1-2 is able to limit the internal layer body 1-1 to evenly expand to a needed shape and size, and a hardness-softness of the internal layer body 1-1, so that a leakage phenomenon is effectively avoided to improve a service life of the ball.

### Embodiment 6

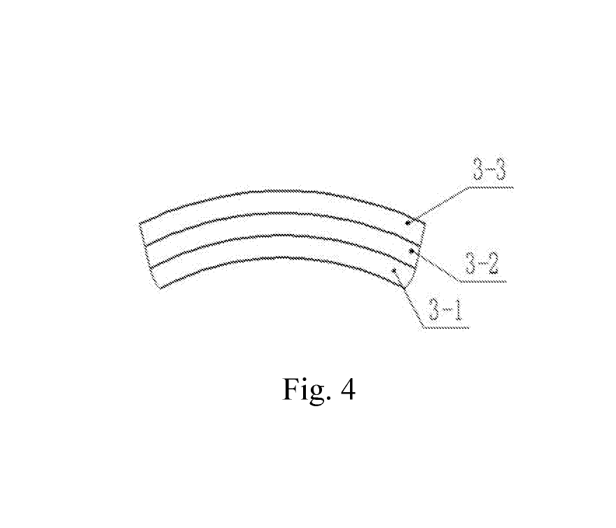

As shown in FIG. 4, preferably, the rubber layer 3 comprises an internal layer rubber 3-1, a yarn reinforcement layer 3-2 and an external layer rubber 3-3, wherein the internal layer rubber 3-1 is attached to an interior of the yarn layer 2, the yarn reinforcement layer 3-2 is attached to an external surface of the internal layer rubber, the external layer rubber 3-3 is attached to an external surface of the yarn reinforcement layer 3-2. In spite that the existing yarn tire is able to avoid a burst during tire inflation and plays a role in forming, due to the ball is mechanically wound with yarns, the yarns are always unevenly wound, so that the ball is unable to be completely controlled to achieve a determined shape. To solve the technical problem, the rubber layer 3 of the present invention further adopts sandwiching the yarn reinforcement layer 3-2 between the internal layer rubber 3-1 and the external layer rubber 3-3. By a double forming of the yarn layer 2 and the yarn reinforcement layer 3-2, the ball is completely controlled to achieve the determined shape, so that when the ball is squeezed in a long term and strongly impacted, the yarn reinforcement layer 3-2 enhances a strength of an impact resistance of the ball, thus ensuring a resilience strength and an excellent jumping ability and prolonging the service life of the ball.

In the above embodiments, the inner tube 4 of the present invention is a football or volleyball inner tube.

According to the structural description of the above embodiments, a manufacturing method of the inner tube 4 provided by the present invention is provided, which comprises steps of:

(1) preparing a tube body 1 fittingly with a roundness of a ball;

(2) preparing a yarn ball comprising injecting gas into the tube body 1, and measuring a periphery thereof, winding yarns around an external surface of the tube body 1 with a yarn winding machine;

(3) preparing a rubber raw material ball by attaching a rubber raw material to an external surface of the yarn ball; and

(4) preparing a vulcanizing inner tube 4 comprising steps of: putting the rubber raw material ball prepared by the step (3) into a vulcanizing mold, communicating a gas injection needle on the vulcanizing mold with a gas nozzle 5 of the rubber raw material ball and pressurizing, heating and vulcanizing with a vulcanizing temperature of 95-160° C., a pressure of 3-10 kg/cm² and a vulcanizing time of 4-10 min, permeating the rubber raw material through yarn gaps after vulcanization, and vulcanizing mould unloading for obtaining the vulcanizing inner tube 4, wherein a circumferential error of the inner tube 4 is less than 2 mm.

Referring to FIG. 2, after the rubber raw material ball is prepared in the step (3), a balance plate is 6 attached to a position where is coaxially aligned with the gas nozzle 5 and symmetrical to a spherical center on the rubber raw material ball, and then the step (4) is processed. The balance plate 6 reduces a derivation of a center of gravity of the inner tube 4 from the spherical center. The balance plate 6 is a rubber plate with a weight equivalent to the gas nozzle 5. The balance plate 6 ensures that the whole center of gravity of the inner tube 4 derivates from the spherical center in small, so that when the inner tube 4 attaches to a housing, due to the weight of the balance plate 6, the whole center of gravity of the ball lies in the spherical center, thus the ball has excellent balance and flight stability.

During the manufacturing process of the inner tube 4, while vulcanizing with the vulcanizing mold, the rubber raw material of the rubber layer 3 permeates through the yarn gaps of the yarn layer 2, in such a manner that the tube body 1, the yarn layer 2 and the rubber layer 3 form a whole to form the inner tube 4 sandwiching the yarns between an inner rubber and an outer rubber, which has compact structure and excellent gas tightness, not only ensures a surface softness after injecting the gas into the inner tube 4, but also increases a rebound ability, and simultaneously, the vulcanizing mold ensures that the circumferential error of the vulcanizing inner tube 4 prepared by vulcanizing mould unloading is in an error range, thereby greatly improving the jumping ability, balance and flight stability of the ball.

The circumferential error of the inner tube 4 provided by the present invention is less than 2 mm and controlled with the vulcanizing mold. The circumferential error of the inner tube 4 gives consideration to both the jumping ability of the ball and the manufacturing cost of production, which includes a control cost of a circumferential accuracy of an internal surface of the vulcanizing mold. The structure of the inner tube 4 provided by the present invention solves the problems of uncontrolled circumferential errors, poor jumping ability, ball derivations, flight instability, poor ball quality, low durability, waste resources and environmental pollution caused by existing yarn ball tires and cloth tires.

According to the Embodiment 4, to improve the gas tightness of the inner tube 4, after the rubber raw material ball is prepared in the step (3), the surface of the inner tube 4 prepared by vulcanizing mould unloading forms the layer of dense rubber membrane, so that the inner tube 4 has excellent gas tightness and durability.

The above descriptions show the basic principle, main characteristics and advantages. One skilled in the art will understand that the embodiment of the present invention as shown in the drawings and described above is exemplary only and not intended to be limiting. It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An inner tube, comprising: a tube body, a yarn layer and a rubber layer, wherein the yarn layer is attached to an external surface of the tube body, the rubber layer is attached to an external surface of the yarn layer and is then vulcanized, in such a manner that a rubber raw material of the rubber layer permeates through yarn gaps of the yarn layer, so as to integrate the tube body, the yarn layer with the rubber layer.

2. The inner tube, as recited in claim 1, wherein the inner tube is a football or volleyball inner tube.

3. The inner tube, as recited in claim 1, wherein a circumferential error of the inner tube is less than 2 mm, and a thickness of the yarn layer is 0.1-1 mm.

4. The inner tube, as recited in claim 1, wherein a balance plate is attached to the inner tube and located at a position where is coaxially aligned with a gas nozzle and symmetrical to a spherical center.

5. The inner tube, as recited in claim 1, wherein the rubber layer is an ordinary rubber layer or a foamed rubber layer; after vulcanization, an external surface of the rubber layer forms a layer of dense rubber membrane.

6. The inner tube, as recited in claim 1, wherein the tube body is a double layer tube body comprising an internal layer body and an external layer body tightly attached to the internal layer body.

7. The inner tube, as recited in claim 1, wherein the rubber layer comprises an internal layer rubber, a yarn reinforcement layer and an external layer rubber, wherein the internal layer rubber is attached to an interior of the yarn layer, the yarn reinforcement layer is attached to an external surface of the internal layer rubber, the external layer rubber is attached to an external surface of the yarn reinforcement layer.

8. A manufacturing method of an inner tube, comprising steps of:
(1) preparing a tube body fittingly with a roundness of a ball;
(2) preparing a yarn ball comprising injecting gas into the tube body, and measuring a periphery thereof, winding yarns around an external surface of the tube body with a yarn winding machine;
(3) preparing a rubber raw material ball by attaching a rubber raw material to an external surface of the yarn ball; and
(4) preparing a vulcanizing inner tube comprising steps of: putting the rubber raw material ball prepared by the step (3) into a vulcanizing mold, communicating a gas injection needle on the vulcanizing mold with a gas nozzle of the rubber raw material ball and pressurizing, heating and vulcanizing with a vulcanizing temperature of 95-160° C., a pressure of 3-10 kg/cm² and a vulcanizing time of 4-10 min, permeating the rubber raw material through yarn gaps after vulcanization, and vulcanizing mould unloading for obtaining the vulcanizing inner tube, wherein a circumferential error of the inner tube is less than 2 mm.

9. The manufacturing method of the inner tube, as recited in claim 8, wherein after the rubber raw material ball is prepared in the step (3), a balance plate is attached to a position where is coaxially aligned with the gas nozzle and symmetrical to a spherical center on the rubber raw material ball, and then the step (4) is processed.

10. The manufacturing method of the inner tube, as recited in claim 8, wherein the inner tube comprises a tube body, a yarn layer and a rubber layer, wherein the yarn layer is attached to an external surface of the tube body, the rubber layer is attached to an external surface of the yarn layer and is then vulcanized, in such a manner that a rubber raw material of the rubber layer permeates through yarn gaps of the yarn layer, so as to integrate the tube body, the yarn layer with the rubber layer.

11. The manufacturing method of the inner tube, as recited in claim 10, wherein the inner tube is a football or volleyball inner tube.

12. The manufacturing method of the inner tube, as recited in claim 11, wherein a circumferential error of the inner tube is less than 2 mm, and a thickness of the yarn layer is 0.1-1 mm.

13. The manufacturing method of the inner tube, as recited in claim 12, wherein the rubber layer is an ordinary rubber layer or a foamed rubber layer; after vulcanization, an external surface of the rubber layer forms a layer of dense rubber membrane.

14. The manufacturing method of the inner tube, as recited in claim 13, wherein the tube body is a double layer tube body comprising an internal layer body and an external layer body tightly attached to the internal layer body.

15. The manufacturing method of the inner tube, as recited in claim 14, wherein the rubber layer comprises an internal layer rubber, a yarn reinforcement layer and an external layer rubber, wherein the internal layer rubber is attached to an interior of the yarn layer, the yarn reinforcement layer is attached to an external surface of the internal layer rubber, the external layer rubber is attached to an external surface of the yarn reinforcement layer.
